(19) United States
(12) Patent Application Publication
(10) Pub. No.: US 2009/0123627 A1
(43) Pub. Date: May 14, 2009

(54) Gluten-free flour composition

(76) Inventor: Jules E.D. Shepard, Catonsville, MD (US)

Correspondence Address: Ober, Kaler, Grimes & Shriver, 120 East Baltimore Street, Baltimore, MD, 21202-1643, US

(21) Appl. No.: 12/288,853

(22) Filed: Oct. 23, 2008

Related U.S. Application Data
(60) Provisional application No. 60/999,955, filed on Oct. 23, 2007.

(51) Int. Cl. A21D 8/02

(52) U.S. Cl. 426/550

(57) ABSTRACT

A gluten-free flour composition for persons with celiac disease or other gluten sensitivity comprising specified quantities of gluten-free white rice flour, gluten-free potato starch, gluten-free corn starch, gluten-free tapioca starch, gluten-free corn flour, and xanthan gum, all mixed thoroughly in dry form and packaged. The gluten free flour mix closely emulates all-purpose wheat flour in taste, consistency, volume, loft and texture, and is suitable as a 1-for-1 substitute for all purpose wheat flour in conventional wheat flour recipes to produce gluten-free breads, cookies, cakes, muffins, sauces, roux, batter and any other type of flour-containing food products.

### CROSS-REFERENCE TO RELATED APPLICATIONS

The present application derives priority from U.S. provisional application No. 60/999,955 filed Oct. 23, 2007.

### BACKGROUND OF THE INVENTION

1. Field of the Invention

The present invention relates to flour used in creating food products and, more particularly, to a gluten-free flour mix for use as an alternative to commercial wheat flour, which emulates the qualities of commercial wheat-flour (and may therefore be used as a base to create gluten-free baked and other food items) but is suitable for consumption by persons with celiac disease, wheat allergy, gluten sensitivity or autistic individuals who benefit from eliminating gluten from their diets.

2. Description of the Background

Gluten is a protein in certain common grains including wheat, barley and rye. Because of the pervasiveness of these grains, gluten is found in vast numbers of commercially-available food products. The ubiquitous nature of gluten causes difficulty for everyone who is sensitive to gluten. Celiac disease—also referred to as gluten sensitive enteropathy or gluten intolerance—is an autoimmune disease which is considered to be one of the most misdiagnosed diseases of our time, and yet it potentially affects at least 1% of our population (approximately 3 million people). It results from an immune response to the ingestion of gluten that damages the small intestine. Nutrients pass through the small intestine rather than being absorbed. Among the myriad possible symptoms of celiac disease are diarrhea, weight loss, abdominal distention, weakness, muscle wasting, growth retardation, and malnutrition. (L. M. Tierney et al. (2003), Current Medical Diagnosis & Treatment: 585 et seq).

To date, no remedy exists for celiac disease and the only treatment is a life-long gluten-free diet. Unfortunately, thanks to the widespread usage of gluten-containing grains in commercial foods, people with gluten sensitivity are severely restricted in the foods available to them. This is especially true of baked goods made with flour, which are nearly always laden with gluten.

A gluten-free flour mixture is necessary for those with celiac disease, wheat allergy, gluten sensitivity as well as many autistic individuals, some of whose extreme behaviors appear to be moderated by eliminating gluten from their diets. Although gluten-free flour mixes have been previously proposed, none are comparable to all-purpose wheat flour in taste, consistency, volume, shelf life, loft and texture, and none may be successfully used as a 1-for-1 substitute for all purpose wheat flour in all types of conventional wheat flour recipes.

It would be greatly advantageous to provide a gluten-free flour composition for use as an alternative to other commercial gluten-free flours, which emulates commercial wheat-based flour and may therefore be used as a base to create gluten-free baked and other food items.

### SUMMARY OF THE INVENTION

It is an object of the present invention to provide a gluten-free flour composition for use as an alternative to commercial wheat flour.

It is another object to provide a gluten-free flour composition that closely emulates commercial wheat-based flour and may therefore be used as 1-to-1 substitute to create gluten-free baked and other food items.

In accordance with the foregoing objects, the present invention is a gluten-free flour composition for persons with celiac disease or other gluten sensitivity comprising specified quantities of gluten-free white rice flour, gluten-free potato starch, gluten-free corn starch, gluten-free tapioca starch, gluten-free corn flour, and xanthan gum, all mixed thoroughly in dry form and packaged. The gluten free flour composition closely emulates all-purpose wheat flour in taste, consistency, volume, shelf life, loft and texture, and is suitable as a 1-for-1 substitute for all purpose wheat flour in conventional wheat flour recipes to produce gluten-free breads, cookies, cakes, muffins, sauces, roux, batter and any other type of flour-containing food products.

Other objects, features, and advantages of the present invention will become more apparent from the following detailed description of the preferred embodiments and certain modifications thereof in which:

### DETAILED DESCRIPTION OF THE PREFERRED EMBODIMENTS

As described above, the present invention is a gluten-free flour composition for use as an alternative to commercial wheat flour. The composition may be used as a base to create gluten-free baked goods, as a thickening agent, a batter, a food coating, and for many other food items.

The gluten-free flour composition according to the present invention generally comprises at least the following ingredients: 1) white rice flour; 2) gluten-free potato starch; 3) gluten-free corn starch; 4) gluten-free modified tapioca starch; 5) fine ground gluten-free corn flour; 6) xanthan gum.

White rice flour is typically produced from grinding polished rice (with bran and germ removed) into a powder. White rice flour is a known thickening agent, and because rice flour contains no gluten it can be used as a suitable substitution for wheat flour for people who cannot tolerate gluten in their diets because of a severe allergic reaction (celiac disease). On the other hand, white rice flour alone is not generally thought to be suitable for baking yeast breads and sources suggest combining it with wheat flour in order to attain the properties of gluten formation necessary for yeast dough to properly rise. A suitable gluten-free white rice flour may be Arrowhead Mills™ Organic White Rice Flour or any other commercially available gluten-free white rice flour.

Potato starch is a gluten-free starch made from cooked, dried and ground potatoes. It is typically used to thicken soups and gravies. For present purposes Authentic Foods™ Gluten-Free Potato Starch or any other commercially available gluten-free potato starch may be used.

Corn starch is the starch of the maize grain, or corn. It is also ground from the endosperm, or white heart, of the corn kernel. It is a known anti-caking agent in powder. The composition of cornstarch varies depending upon feedstock, but generally contains approximately 25% amylose and 75% amylopectin. For present purposes the gluten-free corn starch may be ARGO™ Gluten Free Corn Starch or any other commercially available gluten-free corn starch.

Tapioca is a flavorless starchy ingredient, or fecula, produced from treated and dried cassaya root. Expandex™ tapioca starch (or flour) is a refined white gluten-free flour from pure tapioca that is herein used as a thickener and binder to make up for the lack of gluten. For this formula the gluten-free tapioca starch is a modified variety which increases the shelf life of gluten-free baked goods and enhances the elasticity of the flour mixture.

Corn flour is ground from dried corn. Corn flour is different from corn starch which is also used herein. The latter is a fine chalky white powder. The present invention employs a stone ground gluten free corn flour that retains some of the hull and germ, lending a little more flavor and nutrition to recipes in which it is used. Not all corn flour is prepared gluten-free, and so care must be taken in the selection here. For example, the gluten-free corn flour may be Shiloh Farms™ Organic Gluten-Free Corn flour or other brand that stone grinds from whole kernels of corn.

Xanthan gum is a polysaccharide used as a food additive and rheology modifier. It is produced by a process involving fermentation of glucose or sucrose by the Xanthomonas campestris bacterium. In foods, xanthan gum is often used in salad dressings and sauces to help to stabilize the colloidal oil and solid components against creaming by acting as an emulsifier. Xanthan gum is capable of producing a large increase in viscosity by adding a very small quantity of gum. In other foods it is used at 0.5% by weight, but in the present invention is used in lower concentrations to give the dough or batter a “stickiness” that would otherwise be achieved with the gluten normally found in wheat flour.

The above flour ingredients are combined as follows in approximately the relative parts by weight listed to yield total weight-amount of the present gluten free flour composition:
one and one quarter parts by weight of gluten-free modified tapioca starch +/−10%;
three quarters part by weight of gluten-free potato starch +/−10%;
one part by weight of gluten-free corn starch +/−10%;
one half part by weight of gluten-free white rice flour +/−10%;
one half part by weight of gluten-free corn flour +/−10%;
½ teaspoon of xanthan gum +/−50% for every sixteen ounces by weight amount of the above-combined gluten-free modified tapioca starch, gluten-free potato starch, gluten-free corn starch, gluten-free white rice flour, and gluten-free corn flour.

The combined ingredients are then mixed thoroughly to form a gluten-free flour composition. Finally, the composition is packaged in dry form.

Thus, for example, the above ingredients may be combined as follows in approximately the relative quantities listed:

| Ingredient | Preferred Amount | Acceptable range | |
|---|---|---|---|
| white rice flour | 16 oz | 14.4-17.6 | oz |
| potato starch | 24 oz | 21.6-26.4 | oz |
| corn starch | 32 oz | 28.8-35.2 | oz |
| Expandex ™ tapioca starch | 40 oz | 36-44 | oz |
| fine ground corn flour | 16 oz | 14.4-17.6 | oz |

In the preferred amounts this yields 128 ounces of flour mixture, though of course the amounts needed may be scaled up or down as necessary to achieve the desired end amount. Given the foregoing, ½ teaspoon (0.166666666666667 ounces) of xanthan gum, within a range of +/−50%, is added for every 1 cup (8 ounces) of the flour mixture. Thus, for 128 ounces of flour mixture, 8 teaspoons or 2.67 ounces of xantham gum is added.

Given the raw mixture, the entire composition must be mixed extremely well to prevent any separation of flours and preserve the precise formula. Mixing may take place with any mixing machine and most suitably a commercial-grade mixer. Given the stated ingredients and a close approximation of the relative amounts, combined with proper mixing, the end product closely emulates all-purpose wheat flour in taste, consistency, volume, loft and texture.

The mixed gluten-free flour composition is then packaged in dry form similar to conventional flour mixes. The gluten-free four composition of the present invention may be used as a 1-for-1 substitute for all purpose wheat flour in any conventional wheat flour recipes, thus eliminating the necessity of using exclusively gluten-free recipes to make gluten-free food. The unique qualities of this flour produce gluten-free breads, cookies, cakes, muffins, sauces, roux, batter and any other type of flour-containing food products without using a gluten flour product.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A gluten-free flour composition for persons with gluten sensitivity, comprising:
white rice flour;
potato starch;
corn starch;
tapioca starch;
corn flour; and
xanthan gum.

2. The gluten-free flour composition according to claim 1, wherein said tapioca starch comprises approximately one and one quarter parts by weight of gluten-free Expandex™ tapioca starch within a range of from +/−10%.

3. The gluten-free flour composition according to claim 1, wherein said potato starch comprises approximately three quarters part by weight of gluten-free potato starch within a range of from +/−10%.

4. The gluten-free flour composition according to claim 3, wherein said corn starch comprises approximately 1 part by weight of gluten-free corn starch corn within a range of from +/−10%.

5. The gluten-free flour composition according to claim 4, wherein said white rice flour comprises approximately ½ part by weight of gluten-free white rice flour within a range of from +/−10%.

6. The gluten-free flour composition according to claim 5, wherein said corn flour comprises approximately ½ part by weight of gluten-free corn flour within a range of from +/−10%.

7. The gluten-free flour composition according to claim 6, wherein said xantham gum comprises approximately 0.0834 part by weight of xantham gum within a range of from +/−50%.

8. A volume of gluten-free flour composition for persons with gluten sensitivity, comprising:
three quarters part by weight of gluten-free potato starch within a range of from +/−10%;
one and one quarter parts by weight of gluten-free modified tapioca starch +/−10%;
one part by weight of gluten-free corn starch corn within a range of from +/−10%;
one half part by weight of gluten-free white rice flour within a range of from +/−10%;
one half part by weight of gluten-free corn flour within a range of from +/−10%;
0.0834 part by weight of xantham gum within a range of from +/−50%.

9. The volume of gluten-free flour composition according to claim 8, wherein said tapioca starch comprises Expandex™ tapioca starch.

10. A process for preparing a total weight of gluten-free flour composition for persons having gluten sensitivity, comprising the steps of:
adding 1 and one quarter parts by weight of gluten-free modified tapioca starch;
adding three quarters part by weight of gluten-free potato starch;
adding 1 part by weight of gluten-free corn starch;
adding ½ part by weight of gluten-free white rice flour;
adding ½ part by weight of gluten-free corn flour;
adding 1 teaspoon of xanthan gum for every one part by weight of said combined gluten-free modified tapioca starch, gluten-free potato starch, gluten-free corn starch, gluten-free white rice flour, and gluten-free corn flour;
mixing said combined parts thoroughly to form a gluten-free flour composition; and
packaging said gluten-free flour composition in dry form.
